(19) United States
(12) Patent Application Publication
(10) Pub. No.: US 2023/0030375 A1
(43) Pub. Date: Feb. 2, 2023

(54) USE OF PROTEINS IN 3D PRINTING

(71) Applicant: Arkema France, Colombes (FR)

(72) Inventors: Jean-Luc Dubois, Colombes (FR); Anne-Laure Brocas, LACQ (FR); Sylvie Cazaumayou, LACQ (FR)

(73) Assignee: Arkema France, Colombes (FR)

(21) Appl. No.: 17/787,140

(22) PCT Filed: Dec. 17, 2020
(86) PCT No.: PCT/FR2020/052495

§ 371 Date: Jun. 17, 2022

(30) Foreign Application Priority Data
Dec. 20, 2019 (FR) FR1915170

(51) Int. Cl. B29C 64/118; B33Y 10/00; B33Y 70/10; C08K 3/013; C08K 5/00; C08L 89/00

(52) U.S. Cl. CPC B29C 64/118; B33Y 10/00; B33Y 70/10; C08K 3/013; C08K 5/0016; C08L 89/005

(57) ABSTRACT

The present invention relates to the use of natural polymers of the family of the proteins not exhibiting enzymatic activity as sacrificial materials of 3D fused deposition modeling.

### CROSS-REFERENCE TO RELATED APPLICATIONS

This application is a 371 filing of International Application No. PCT/FR2020/052495, filed Dec. 17, 2020, which claims priority to French Application No. 1915170, filed Dec. 20, 2019, the disclosure of these applications being incorporated herein by reference in their entireties for all purposes.

### FIELD OF THE INVENTION

The present invention relates to the use of natural polymers of the family of the proteins not exhibiting enzymatic activity as sacrificial materials of 3D fused deposition modeling.

Such materials exhibit rapid dissolution or dispersibility in water while combining the ideal thermomechanical properties to make strings or rods therefrom which can be used in 3D printing (fused deposition modeling).

These materials furthermore result from a natural resource and are biodegradable.

As regards more particularly the field of three-dimensional printing (or 3D printing), this technology makes possible the additive manufacturing (or AM) of a real object from a virtual object. It is based on cutting the 3D virtual object into 2D slices of very thin thickness. These thin slices are deposited one by one by fixing them onto the preceding slices, which reconstitutes the real object. The constituent materials of the object include plastics (in particular acrylonitrile-butadiene-styrene (or ABS) and polylactic acid (or PLA)), wax, metal or ceramics. Examples of additive techniques are fused filament fabrication (FFF) and laser sintering.

### BACKGROUND OF THE INVENTION

Fused deposition modeling is a mechanical technique which consists in melting a filament of synthetic substance (generally plastic of ABS or PLA type) through an extrusion nozzle heated to a temperature varying between 160 and 270° C. A molten filament, with a diameter of the order of a tenth of a millimeter, emerges from this nozzle. This string is deposited in a line and bonds by remelting onto that which was deposited previously. This technique makes it possible to create parts made of proper substance, which have mechanical and thermal characteristics and a stability which are identical to those of injection-molded thermoplastic parts. This technique also has a major advantage regarding the structure of the support necessary for the production of the parts, which is also extruded jointly, since this construction support in most cases consists of another substance than that constituting the object created, which substance is removed from said object, when the process for the construction of the latter is finished.

The construction support is generally a water-soluble or water-dispersible polymer composition corresponding to very precise specifications. Among the desired properties, in addition to the mechanical strength, the glass transition temperature of the copolymer, which has to be similar to that of the material to be printed, its thermal stability or its processability, the kinetics of dissolution or of dispersibility in water are of primary importance.

This 3D printing technique requires support materials making possible the construction of complex parts; this is, for example, described in WO2010/045147. The other support materials include:

polyvinyl alcohol (soluble in water with very long times),

high-impact polystyrene, soluble in limonene,

butanediol/vinyl alcohol BVOH copolymer, soluble in water,

(meth)acrylic copolymers,

detachable supports.

The major disadvantages are: the nature of the support materials, as well as the medium in which the latter are dissolved and/or dispersed. The support materials mainly result from fossil resources. In addition, they dissolve under specific conditions: solvent, high pH, temperature. These support polymers can only be used by professionals and not by private individuals. In addition, the products of degradation/dissolved in water are not biodegradable in this medium. It is therefore undesirable to use them in a domestic environment where waste water is routed to treatment plants that cannot handle these products.

A new formulation based on proteins, on additives and, if appropriate, on enzymes has been developed to be used as support material. This formulation exhibits the advantage of constituting a material dedicated to 3D printing and the enzymes present make it possible to improve the dispersibility in domestically available water (“faucet water”). This formulation is easily and quickly dissolved, indeed even hydrolyzed.

The proteins used are biodegradable polymers. Among biodegradable polymers, polyesters can be used as printable materials. However, they do not have the properties of not only being soluble in an aqueous medium but also having good mechanical properties (similar to the properties of the printed material). Polylactic acid is also a biodegradable polymer (compostable in an industrial environment, but not degradable in an aqueous medium) but which is soluble only in solvents of dichloromethane, THF or chloroform type. The proteins used in this formulation can be combined with an enzyme so that they can be dispersed under mild conditions. For domestic use, the 3D printed material with its sacrificial composition can be placed in a dishwasher with a dose of commercial soap which will give the pH appropriate for facilitating the dissolution and the dispersion; and in the case of a need for an acid pH for a formulation with an enzyme, a dose of household vinegar can be added to the compartment of the dishwasher. Alternatively, it might also be possible to add a dose of baking powder (sodium bicarbonate) to adjust the basicity.

The formulation proposed here is based on a formulation containing a protein, one or more plasticizer(s), a surfactant and, if appropriate, at least one enzyme. This formulation makes it possible to have a material printable in 3D and which supports the printed material. The addition of enzymes makes this formulation rapidly hydrolyzable under domestic conditions.

Advantageously, and this being done in order to obtain a filament which is easier to extrude, the formulation also comprises a filler.

### SUMMARY OF THE INVENTION

The invention thus relates to the use of a composition as sacrificial material of 3D fused deposition modeling, this composition comprising:

at least one protein not exhibiting enzymatic activity,

at least one plasticizer,

water.

### BRIEF DESCRIPTION OF THE DRAWINGS

The FIGURE shows a reel of filaments obtained by extrusion spinning of a composition according to example 2.

### DETAILED DESCRIPTION OF THE INVENTION

Dissolution or dispersibility in water is understood to mean dissolution or dispersibility in an aqueous phase, the pH of which is between 5.5 and 14, limits included and at a temperature of between 25 and 70° C.

A copolymer is said to be “dispersible” if it forms, at a concentration of 5% by weight in a solvent, at 25° C., a stable suspension of fine, generally spherical, particles. The mean size of the particles constituting said dispersion is less than 1 μm and, more generally, varies between 5 and 400 nm, preferably from 10 to 250 nm, by weight. These particle sizes are measured by light scattering.

When the solvent is water, the term used is “water-dispersible” copolymer.

The proteins of animal or plant origin which can be used in the context of the invention can be the following, in a non-limiting way:

gelatins, fibrillary proteins, whey, albumin, keratin, soybean, wheat or corn proteins or proteins resulting from other plants, or also caseins and caseinates. Preferably, they are caseins or caseinates.

According to a first aspect of the invention, the proportions of the compositions used in the invention can be as follows:

The proportions of caseins or caseinates are between 50% and 90% by weight of the composition used in the invention.

Casein is understood to mean any type of casein or caseinate and preferably caseinates.

The proportions of water are between 5% and 25% by weight of the composition used in the invention.

The plasticizers present in the composition used in the invention can include any type of plasticizer and in particular glycerol, the proportions of which can vary from 5% to 25% by weight.

Enzymes can be added to the composition. They make possible the hydrolysis of the protein(s) used in the composition: they can also be added subsequently, when placing the object in the dishwasher.

The compositions used in the invention can be formed in the form of an extruded filament, these extruded filaments also being a subject matter of the invention.

To this end, according to a second aspect of the invention, the compositions used in the compositions of the invention can contain fillers. Their natures and amounts can vary.

The fillers which can be used in the compositions used in the invention can include an inorganic or organic filler or both, in powder or fiber form.

Proportions of inorganic and organic fillers can be from 2% to 60% by weight of the composition.

The inorganic fillers can be chalk, carbonates, talcs or clays, and preferably carbonates, more particularly calcium carbonate.

The organic fillers can be sugars, preferably, flours of wood, of fruit peels or of kernels, plant fibers such as cotton, wood, cellulose pulp or also starches. Some polymers, such as polyethylene glycols, fall within this scope.

A typical composition of this other aspect of the invention will comprise the following elements:

casein and caseinate: from 30% to 60% by weight,

water: from 5% to 15% by weight,

glycerol: from 10% to 25% by weight,

filler: from 2% to 60% by weight.

The invention also relates to the objects obtained by means of the use of the compositions of the invention.

### Example 1:

The mixture of reactants for the formulation of the invention is as follows:

70% by weight of casein from bovine milk C7078 (Sigma Aldrich); the casein composition of the milk is, in (g/l): α-s1 (12-15); α-s2 (3-4); β (9-11); and κ (2-4),

10% by weight of water,

20% by weight of glycerol.

The formulation is stirred at ambient temperature for 10 minutes and is then heated to a temperature of 160° C. under a compression molding press to form a pellet with a diameter of 2.5 cm and a thickness of 1 mm. The pellet is subsequently placed in a beaker, with stirring, in an alkaline medium at pH=12 (buffer solution) at a temperature of 60° C., which are typical conditions of washing in a dishwasher.

The formulation described is compared with commercial sacrificial polymers: commercial grade 1 (3D Gence ESM 10 from 3D Gence) and commercial grade 2 (13 CGPH007 13% Elvaloy reference SR 30 from Stratasys). These are sacrificial (meth)acrylic polymers soluble at pH 12 and 60° C. tested in the form of pellets according to the same protocol as for the invention.

The samples are periodically removed and weighed in order to evaluate the weight loss as % linked to the dissolution of the formulation. The tests are carried out at a pH of 12 at 60° C. (table 1).

TABLE 1

| Table 1 | | Commercial | Commercial |
|---|---|---|---|
| Time | | grade | grade |
| (min) | Invention | 1 | 2 |
| 0 | 0.00% | 0.00% | 0.00% |
| 10 | 45.63% | −2.32% | |
| | | | 5.69% |
| 20 | 100.00% | 16.09% | |
| 30 | | 46.19% | 8.94% |
| 40 | | 60.98% | |
| | | | 14.63% |
| 50 | | 71.18% | |
| 60 | | | 18.70% |
| 65 | | 87.25% | |
| 75 | | 100.00% | 23.58% |
| 90 | | | 28.46% |
| tableau 1 | | | |
| Temps | | Grade commercial | Grade commercial |
| (mn) | Invention | 4 | 2 |
| 0 | 0.00% | 0.00% | 0.00% |
| 10 | 45.63% | -2.32% | |
| | | | 5.69% |
| 20 | 100.00% | 16.09% | |
| 30 | | 46.19% | 8.94% |
| 40 | | 60.98% | |
| | | | 14.63% |
| 50 | | 71.18% | |
| 60 | | | 18.70% |
| 65 | | 87.25% | |
| 75 | | 100.00% | 23.58% |
| 90 | | | 28.46% |

It is found that the formulation of the invention dissolves more rapidly than the formulations of commercial grades 1 and 2.

### Example 2:

The mixture of reactants for the formulation of the invention is as follows:

34% by weight of casein from bovine milk C7078 (Sigma Aldrich); the casein composition of the milk is, in (g/l): α-s1 (12-15); α-s2 (3-4); β (9-11); and κ (2-4),

7% by weight of water,

18% by weight of glycerol,

41% by weight of CaCO₃ with a particle size of between 100 and 150 pm.

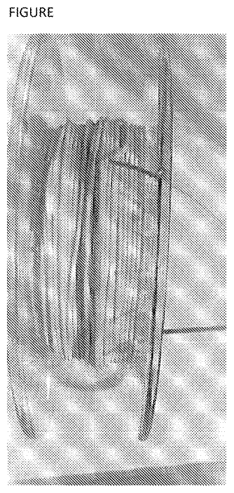

The composition is extruded with a thermal profile of less than 100° C. A filament is obtained. This filament can be wound (FIG. 1) and be used as sacrificial support in a device for the 3D printing of polymers, and be subsequently removed by dissolution.

The figure shows a reel of filaments obtained by extrusion spinning of a composition according to example 2.

1. A method of 3D fused deposition modeling conducted in the presence of a sacrificial composition comprising:
at least one protein not exhibiting enzymatic activity,
at least one plasticizer, and
water.

2. The method as claimed in claim 1, wherein the composition additionally comprises a filler.

3. The method as claimed in claim 2, wherein the filler is inorganic.

4. The method as claimed in claim 2, wherein at least one protein is from the family of caseins or caseinates.

5. The method as claimed in claim 1, wherein the composition additionally comprises an enzyme.

6. The method as claimed in claim 1, wherein at least one plasticizer is glycerol.

7. The method as claimed in claim 6, wherein the composition comprises:
from 30% to 60% by weight of a compound of the family of caseins or caseinates,
from 5% to 15% by weight of glycerol,
from 10% to 25% by weight of water, and
from 2% to 60% by weight of fillers.

8. An extruded filament resulting from the composition defined in claim 1.
